(19) United States
(12) Patent Application Publication
(10) Pub. No.: US 2024/0293203 A1
(43) Pub. Date: Sep. 5, 2024

(54) METHOD OF GENERATING DESIGNS OF SHELL-SHAPED TOOTH REPOSITIONERS

(71) Applicant: WUXI EA MEDICAL INSTRUMENTS TECHNOLOGIES LIMITED, Wuxi, Jiangsu (CN)

(72) Inventors: Ketuo ZHOU, Shanghai (CN); Yikan ZHENG, Shanghai (CN); Lei HUANG, Shanghai (CN)

(21) Appl. No.: 18/573,311

(22) PCT Filed: Jun. 21, 2022
(86) PCT No.: PCT/CN2022/100124

§ 371 Date: Dec. 21, 2023

(30) Foreign Application Priority Data
Jun. 25, 2021 (CN) 202110716622.4
Jun. 25, 2021 (CN) 202110717119.0
Oct. 19, 2021 (CN) 202111218778.6

(51) Int. Cl. A61C 7/08; A61C 7/00

(52) U.S. Cl. CPC A61C 7/08; A61C 7/002

(57) ABSTRACT

One aspect of the present application provides a computer-implemented method of generating designs of shell-shaped tooth repositioners, the method comprising: obtaining an orthodontic treatment plan comprising a series of successive repositioning steps whose repositioning targets are successive tooth arrangements including a first intermediate tooth arrangement, . . . a final intermediate tooth arrangement and a target tooth arrangement; obtaining reference designs of a series of successive shell-shaped tooth repositioners corresponding to the series of successive repositioning steps; calculating whether the reference designs of the series of successive shell-shaped tooth repositioners can achieve corresponding repositioning targets; and if the reference design of a shell-shaped tooth repositioner in a repositioning step cannot achieve the repositioning target of the repositioning step, modifying the geometry of a corresponding part of the reference design of the shell-shaped tooth repositioner of the repositioning step, to improve force application of the shell-shaped tooth repositioner to obtain an optimized design of the shell-shaped tooth repositioner of this repositioning step.

### FIELD OF THE APPLICATION

The present application generally relates to a method of generating designs of shell-shaped tooth repositioners.

### BACKGROUND

Due to advantages on aesthetic appearance, convenience and ease of cleaning etc., shell-shaped tooth repositioners made of polymer materials become more and more popular.

A method of designing and making a shell-shaped tooth repositioner is forming on a model of teeth that matches a target tooth arrangement of a repositioning step the shell-shaped tooth repositioner of this repositioning step by thermoplastically forming with a heated and softened polymer film. The shell-shaped tooth repositioner is an integral shell and forms a tooth-receiving cavity. When worn on the patient's teeth, the shell-shaped tooth repositioner is subject to elastic deformation due to the difference between the current tooth arrangement and the target tooth arrangement, and the elastically deformed shell-shaped tooth repositioner applies an elastic force on the corresponding teeth to reposition the patient's teeth to the target tooth arrangement. FIG. 1 schematically illustrates a shell-shaped tooth repositioner 11 and a corresponding dentition 13.

The Inventor of the present application believes that the conventional designs of shell-shaped tooth repositioners are still in geometry-designing phase and lacks analysis of forces received by teeth during a treatment, and particularly lacks verification of movements of teeth under loading condition. Therefore, this kind of design might cause the following problems: (1) actual positions of teeth after a single-step repositioning are inconsistent with the designed positions. A current solution is taking the designed poses (i.e., target poses) of the teeth in a previous repositioning step as an input (i.e., initial poses) of the designing of the target poses of the next repositioning step, thereby causing gradual accumulation of deviations between designed displacements of teeth and actual displacements of teeth of various repositioning steps. When the deviation accumulates to a certain degree, the repositioning capability of the shell-shaped tooth repositioner will be affected seriously. (2) Since the designing of target poses of teeth does not take into consideration the mechanics performance of the shell-shaped tooth repositioner, the design process lacks the verification of forces applied to the teeth, so risks such as application of an excessive force and the failure to apply a desired force cannot be avoided.

To overcome the above problems, a method of designing shell-shaped tooth repositioners emerged, which takes repositioning forces into consideration, and this method enables application of expected forces on the teeth by changing the repositioning path of the teeth. In order to satisfy the mechanics performance, dental professionals have to compromise in terms of occlusion relationship and process control when designing repositioning steps so that the treatment plan is limited.

Therefore, it is necessary to provide a new method of designing and making shell-shaped tooth repositioners to solve the above problems.

### SUMMARY

In one aspect, the present application provides a computer-implemented method of generating designs of shell-shaped tooth repositioners, the method comprising: obtaining an orthodontic treatment plan comprising a series of successive repositioning steps whose repositioning targets are successive tooth arrangements which include a first intermediate tooth arrangement, . . . a final intermediate tooth arrangement and a target tooth arrangement; obtaining reference designs of a series of successive shell-shaped tooth repositioners corresponding to the series of successive repositioning steps; calculating whether the reference designs of the series of successive shell-shaped tooth repositioners are able to achieve corresponding repositioning targets; and if a reference design of a shell-shaped tooth repositioner of a repositioning step is not able to achieve the repositioning target of the repositioning step, modifying geometry of a corresponding part of the reference design of the shell-shaped tooth repositioner of the repositioning step, to improve force application of the shell-shaped tooth repositioner to obtain an optimized design of the shell-shaped tooth repositioner of this repositioning step.

In some embodiments, the reference designs of the series of successive shell-shaped tooth repositioners may be directly generated respectively based on the geometries of the repositioning targets.

In some embodiments, the geometries of the reference designs of the series of successive shell-shaped tooth repositioners may match the repositioning targets of the series of successive repositioning steps.

In some embodiments, the optimized design of the shell-shaped tooth repositioner may differ from the corresponding reference design in geometry only.

In some embodiments, the shell-shaped tooth repositioner forms a cavity for receiving a plurality of teeth, a part thereof for receiving a single tooth may be referred to as a tooth cavity of the tooth, and the optimized design of the shell-shaped tooth repositioner may allow partial overlap of tooth cavities of two adjacent teeth.

In some embodiments, the partial overlap of the tooth cavities allowed by the optimized design of the shell-shaped tooth repositioner may be in a range of 0.3˜0.5 mm.

In some embodiments, the shell-shaped tooth repositioner may form a cavity for receiving a plurality of teeth and accessories attached to surfaces of the teeth, a part thereof for receiving a single tooth may be referred to as a tooth cavity of the tooth, a part thereof for receiving an accessory may be referred to as an accessory cavity of the accessory, and the optimized design of the shell-shaped tooth repositioner may allow partial overlap of the tooth cavity and the accessory cavity.

In some embodiments, the computer-implemented method of generating designs of shell-shaped tooth repositioners may further comprise: for each of the series of successive repositioning steps, calculating, based on its initial tooth arrangement and target tooth arrangement, an ideal force system for repositioning the teeth from the initial tooth arrangement to the target tooth arrangement; calculating, based on the initial tooth arrangement and the reference design of the shell-shaped tooth repositioner, a reference force system applied to the teeth when the shell-shaped tooth repositioner of the reference design is worn on the teeth under the initial tooth arrangement; and modifying the reference design based on the ideal force system and the reference force system to obtain the optimized design.

In some embodiments, the computer-implemented method of generating designs of shell-shaped tooth repositioners may further comprise: calculating, based on given conditions taking the ideal force system as a target, an optimized force system; and modifying the reference design according to a difference between the reference force system and the optimized force system to obtain the optimized design.

In some embodiments, the computer-implemented method of generating designs of shell-shaped tooth repositioners may further comprise: according to a user instruction, presenting one of the following of a selected repositioning step on a user interface: a compensatory force system, a compensatory design amount, an equivalent compensatory design amount and any combinations thereof, wherein the compensatory force system is a difference between the reference force system and the optimized force system, the compensatory design amount is a difference between design amounts of the reference design and the optimized design, and the equivalent compensatory design amount is a compensatory design amount obtained by calculating based on the compensatory force system.

In some embodiments, the computer-implemented method of generating designs of shell-shaped tooth repositioners may further comprise: presenting the patient's jaw on the user interface, wherein each tooth having a compensatory force system is tagged with a mark to indicate one of the following: the compensatory force system, a compensatory design amount and an equivalent compensatory design amount.

In some embodiments, the given conditions may comprise: a maximum load of a shell-shaped tooth repositioner calculated based on a given material and thickness of the shell-shaped tooth repositioner.

In some embodiments, the force system may be a sum of a static force and a static torque.

In some embodiments, the computer-implemented method of generating designs of shell-shaped tooth repositioners may further comprise: obtaining a 3D digital model representing the patient's initial tooth arrangement and a diagnosis conclusion provided by a dentist; generating the orthodontic treatment plan based on the 3D digital model representing the patient's initial tooth arrangement and the diagnosis conclusion; and generating the reference designs of the series of successive shell-shaped tooth repositioners after obtaining the dentist's confirmation of the orthodontic treatment plan.

In some embodiments, modifying the geometry of the corresponding part of the reference design of the shell-shaped tooth repositioner of the repositioning step may comprise one of the following: changing relative positional relationship between tooth cavities, changing the geometry of tooth cavities, adding a local pressure point, adding a local reinforcing structure, and any combinations thereof, wherein the shell-shaped tooth repositioner may form a cavity for receiving a plurality of teeth, and a part thereof for receiving a single tooth may be referred to as a tooth cavity of the tooth.

In another aspect, the present application provides a shell-shaped tooth repositioner system, comprising a series of successive shell-shaped tooth repositioners for incrementally repositioning the teeth from an initial tooth arrangement to a first intermediate tooth arrangement, . . . a final intermediate tooth arrangement until a target tooth arrangement, wherein the series of successive shell-shaped tooth repositioners are obtained by modifying reference designs of the series of successive shell-shaped tooth repositioners, the modifications are based on differences between actual repositioning performances and desired repositioning performances of the reference designs of the series of successive shell-shaped tooth repositioners, and geometry of at least one of the series of successive shell-shaped tooth repositioners is different from that of the corresponding reference design, wherein the reference designs of the series of successive shell-shaped tooth repositioners may be directly generated respectively based on the first intermediate tooth arrangement, . . . the final intermediate tooth arrangement and the target tooth arrangement respectively.

In some embodiments, the geometries of the reference designs of the series of successive shell-shaped tooth repositioners may match the first intermediate tooth arrangement, . . . the final intermediate tooth arrangement and the target tooth arrangement, respectively.

In some embodiments, the actual repositioning performances and the desired repositioning performances may be expressed by static force systems.

In a further aspect, the present application provides a computer-implemented method of generating designs of shell-shaped tooth repositioners, the method comprising: obtaining an initial tooth arrangement and a target tooth arrangement of a first repositioning step; obtaining a reference design of the shell-shaped tooth repositioner of the first repositioning step; calculating a force system applied when the shell-shaped tooth repositioner of the reference design is worn on the patient's teeth under the initial tooth arrangement, which force system is referred to as a reference force system; calculating, based on the initial tooth arrangement and the target tooth arrangement, an ideal force system, wherein to reposition the patient's teeth from the initial tooth arrangement to the target tooth arrangement, the ideal force system is required when the shell-shaped tooth repositioner is worn on the patient's teeth; and modifying the reference design based on the reference force system and the ideal force system to obtain an optimized design.

In some embodiments, the reference design may be directly generated based on the target tooth arrangement.

In some embodiments, the geometry of the cavity of the reference design for receiving teeth matches the target tooth arrangement.

In some embodiments, the computer-implemented method of generating designs of shell-shaped tooth repositioners may further comprise: obtaining an initial tooth arrangement and an optimized design of a shell-shaped tooth repositioner of a second repositioning step, wherein the second repositioning step is the previous repositioning step of the first repositioning step; and calculating, based on the initial tooth arrangement and the optimized design of the shell-shaped tooth repositioner of the second repositioning step, the initial tooth arrangement of the first repositioning step.

In some embodiments, the computer-implemented method of generating designs of shell-shaped tooth repositioners may further comprise: calculating, based on given conditions by taking the ideal force system as target, an optimized force system; and modifying the reference design according to a difference between the reference force system and the optimized force system to obtain the optimized design.

In some embodiments, the force system may be a sum of a static force and a static torque.

In some embodiments, the given conditions may comprise: maximum load of the shell-shaped tooth repositioner calculated based on a given material and thickness.

In some embodiments, the given conditions may further comprise one of the following: maximum load of an anchorage tooth, root-control requirement, vertical direction control requirement, and any combinations thereof.

In some embodiments, the modification may comprise one of the following: changing relative positional relationship between tooth cavities, adding an artificially-designed structure and a combination thereof, wherein the shell-shaped tooth repositioner forms a cavity for receiving a plurality of teeth, and a part thereof for receiving a single tooth may be referred to as a tooth cavity of the tooth.

In some embodiments, the artificially-designed structure may comprise one of the following: local geometry modification, force-applying structure at a point, local reinforcing structure and any combination thereof.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the scope of the present application. Unless otherwise specified, the figures are not necessarily drawn to scale, and similar reference numbers therein denote similar components.

FIG. 1 schematically illustrates a shell-shaped tooth repositioner and a corresponding dentition.

FIG. 2 schematically illustrates a flow chart of a method of making a shell-shaped tooth repositioner according to an embodiment of the present application.

FIG. 3A schematically illustrates an optimized design of a shell-shaped tooth repositioner according to an embodiment of the present application.

FIG. 3B schematically illustrates additional forces applied to a tooth when the shell-shaped tooth repositioner shown in FIG. 3A is worn on the teeth.

FIG. 4 schematically illustrates an optimized design of a shell-shaped tooth repositioner according to an embodiment of the present application.

FIG. 5 schematically illustrates a user interface of a computer program for generating designs of shell-shaped tooth repositioners in an example of the present application.

FIG. 6 schematically illustrates a user interface of a computer program for generating designs of shell-shaped tooth repositioners in another example of the present application.

FIG. 7 schematically illustrates a block diagram of a system 200 for designing and manufacturing a shell-shaped tooth repositioner according to an embodiment of the present application.

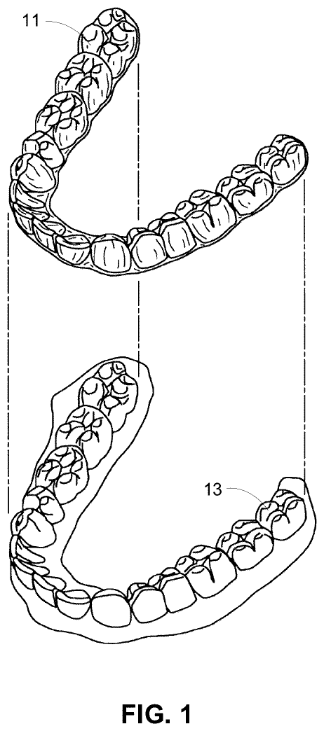

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

An orthodontic treatment utilizing shell-shaped repositioners is wearing a plurality of successive shell-shaped tooth repositioners in order to incrementally re-position a patient's teeth from an initial tooth arrangement to a first intermediate tooth arrangement, a second intermediate tooth arrangement . . . a final intermediate tooth arrangement until a target tooth arrangement.

In order to overcome the drawbacks of conventional methods of designing shell-shaped tooth repositioners, one aspect of the present application provides a new method of designing and making shell-shaped tooth repositioners. Two shell-shaped tooth repositioners two adjacent repositioning steps are taken for an example, i.e., a first shell-shaped tooth repositioner for repositioning the teeth from a first tooth arrangement to a second tooth arrangement, and a second shell-shaped tooth repositioner for repositioning the teeth from the second tooth arrangement to a third tooth arrangement, wherein the first tooth arrangement, the second tooth arrangement and the third tooth arrangement are successive tooth arrangements. In one embodiment, designs of the two shell-shaped tooth repositioners of the two adjacent repositioning steps may be generated by the following method.

First, an initial design of the first shell-shaped tooth repositioner is generated based on the first tooth arrangement and the second tooth arrangement. Then, a first ideal force system needed to reposition the teeth from the first tooth arrangement to the second tooth arrangement, a first reference force system that can be achieved by the original design (also referred to as reference design) of the first shell-shaped tooth repositioner, and a first optimized force system (calculated based on given conditions by taking the first ideal force system as target) are calculated. After that, an optimized design of the first shell-shaped tooth repositioner is generated according to a difference between the first optimized force system and the first reference force system, based on the initial design of the first shell-shaped tooth repositioner. Then, a fourth tooth arrangement that can be achieved by the optimized design of the first shell-shaped tooth repositioner is calculated, wherein the fourth tooth arrangement is different from the second tooth arrangement.

The above operations are repeated based on the fourth tooth arrangement and the third tooth arrangement to obtain an optimized design of the second shell-shaped tooth repositioner. Lastly, the optimized designs of the first and second shell-shaped tooth repositioners are used to control an apparatus to make the first and second shell-shaped tooth repositioners.

In one embodiment, a simplest example of the initial design of a shell-shaped tooth repositioner is that geometry of its teeth-receiving cavity matches a target tooth arrangement of a corresponding repositioning step.

It is understood that the successive first to third tooth arrangements may be in any phase of a treatment plan, for example, the first tooth arrangement may be the patient's initial tooth arrangement or a tooth arrangement that can be achieved by an optimized design of a shell-shaped tooth repositioner of a repositioning step.

It is understood that the tooth arrangements in the initial treatment plan might be different from the tooth arrangements that can be achieved by the shell-shaped tooth repositioners made by the method of the present application. Therefore, in the present application, there are two groups of tooth arrangements: one group is a series of successive tooth arrangements of the treatment plan (i.e., tooth arrangements designed by a dental professional), and the other group is a series of successive tooth arrangements that can be achieved by the shell-shaped tooth repositioners.

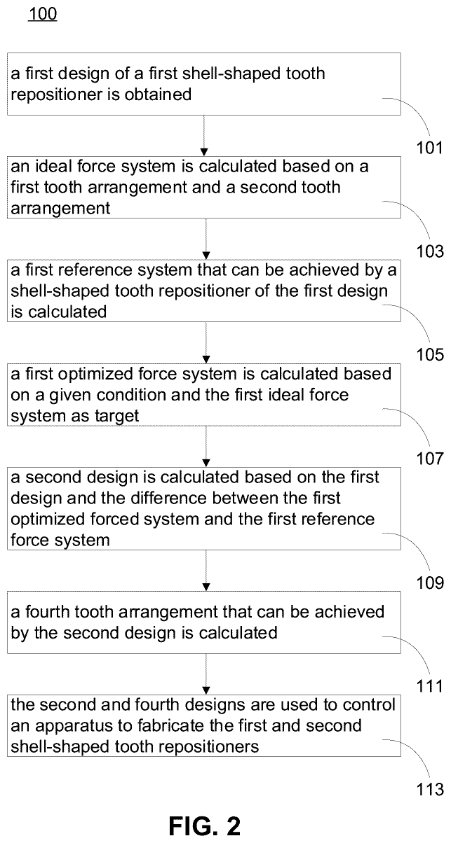

Referring to FIG. 2, it schematically illustrates a flow chart of a method 100 of making shell-shaped tooth repositioners according to an embodiment of the present application. In the following example, fabrication of only two shell-shaped tooth repositioners of two successive repositioning steps is described in detail, which are referred to as a first shell-shaped tooth repositioner and a second shell-shaped tooth repositioner, respectively, which are designed to reposition the teeth from the first tooth arrangement to the second tooth arrangement and then to the third tooth arrangement.

In 101, a first design of a first shell-shaped tooth repositioner is obtained.

The first design is a design of a single shell-shaped tooth repositioner and is a reference design with a design target of repositioning the patient's teeth from the first tooth arrangement to the second tooth arrangement.

In one embodiment, the geometry of a teeth-receiving cavity of the first shell-shaped tooth repositioner in the first design of the first shell-shaped tooth repositioner matches the patient's teeth under the second tooth arrangement. It is understood that the first design as the reference design is not limited to this design, and it may be any other suitable design, e.g., a design of the shell-shaped tooth repositioner with a design amount which is increased based on experience, the increased design amount is not verified by calculation. In one embodiment, the first design of the first shell-shaped tooth repositioner may comprise a thickness of a film for making the shell-shaped tooth repositioner and performance of the material.

In 103, an ideal force system is calculated based on the first tooth arrangement and the second tooth arrangement.

After extensive research and experiments, the Inventors of the present application believe that there is a definite relationship between static force systems (comprising static forces and static torques applied on the teeth) applied on the teeth when the shell-shaped tooth repositioner is worn on the teeth (assuming that the whole dentition is rigid) and repositioning amounts of the teeth that can be achieved by the static force systems. Hence, in a case a repositioning amount of a tooth are known, an ideal force system may be calculated reversely. If the ideal force system can be applied when a shell-shaped tooth repositioner is worn on the patient's teeth under the first tooth arrangement, it may be believed that the shell-shaped tooth repositioner can reposition the patient's teeth from the first tooth arrangement to the second tooth arrangement.

In one embodiment, the ideal force system may be calculated based on a simplified mathematical model.

When the simplified mathematical model is used to calculate the force system, the calculation may be based on the following assumptions: (1) the repositioner-teeth-periodontal ligament system is a linear system, and displacement amount of a tooth is linear with respect to a load; (2) loads corresponding to repositioning amounts of a same tooth in all directions and loads corresponding to repositioning amounts of various teeth are linearly addible.

In one embodiment, a simulation may be performed using a matrix calculating tool based on the simplified mathematical model to calculate the ideal force system. In one embodiment, in the simulation, rigid constraint may be established between the outer boundary of the periodontal ligament and origins of the teeth (i.e., the origins of local coordinate systems of the teeth) (relative movement of the two is relative movement of two rigid bodies), and corresponding displacement constraints may be applied to the origins of the teeth. For an anchorage tooth, a boundary condition of being rigidly fixed may be applied to its origin; for a tooth to be repositioned, the following displacement constraint may be applied to its origin: a displacement in a designed displacement direction is obtained by multiplying a design amount by −1, and displacements in the rest directions are 0.

Under a global coordinate system, a rigidity relationship between the displacements of various teeth in all directions and a constraint reaction of the origin may be established and expressed by the following Equation (1):

$$K U = F \qquad Equation ( 1 )$$

$$wherein ,$$

$$K = ( \begin{matrix}{k}_{( 1 , 1 )} & ⋯ & {k}_{( 1 , 14 )} \\ ⋮ & ⋱ & ⋮ \\ {k}_{( 14 , 1 )} & ⋯ & {k}_{( 14 , 14 )}\end{matrix} ) \qquad Equation ( 2 )$$

wherein k_{(i,j)} is an item in the i^{th} row and the j^{th} column in the matrix K and stands for a local rigidity matrix between the origin of the i^{th} tooth and the six freedom degrees of the j^{th} tooth,

$${k}_{i , j} = ( \begin{matrix}{k}_{( i , j ) 1 , 1} & ⋯ & {k}_{( i , j ) 1 , 6} \\ ⋮ & ⋱ & ⋮ \\ {k}_{( i , j ) 6 , 1} & ⋯ & {k}_{( i , j ) 6 , 6}\end{matrix} ) \qquad Equation ( 3 )$$

A single jaw has a total of 14 teeth, and each tooth has six freedom degrees. Therefore, the matrix K is a 84*84 matrix.

In one embodiment, when the ideal force system is calculated, since the repositioner is absent, in the matrix K only items on a main diagonal are non-zero items, and the rest items are zero items, and the matrix is marked as Kₜ. In one embodiment, each value on the diagonal of the matrix Kₜ may be obtained by simulation based on single-tooth forced displacement constraint.

For example, a single-step maximum repositioning amount in each given direction of each tooth is u, the load L of the tooth in this direction may be obtained by simulation, and the corresponding value on the diagonal of the matrix Kₜ is L/u.
wherein,

$$U = ( \begin{matrix}{u}_{( 1 )} \\ ⋮ \\ {u}_{( 14 )}\end{matrix} ) \qquad Equation ( 4 )$$

wherein U₍ᵢ₎ is an item in the i^{th} row of a matrix U and stands for the repositioning amount of the i^{th} tooth,

$${u}_{( i )} = ( \begin{matrix}{u}_{( i ) 1} \\ {u}_{( i ) 2} \\ ⋮ \\ {u}_{( i ) 6}\end{matrix} ) \qquad Equation ( 5 )$$

wherein u₍ᵢ₎₁˜u₍ᵢ₎₆ respectively stand for the repositioning amounts of the origin of the i^{th} tooth in directions of three translational degrees of freedom and three rotational degrees of freedom (i.e., the repositioning amounts and rotational amounts in x-axis, y-axis and z-axis),

$$F = ( \begin{matrix}{f}_{( 1 )} \\ ⋮ \\ {f}_{( 14 )}\end{matrix} ) \qquad Equation ( 6 )$$

wherein f₍ᵢ₎ is an item in the i^{th} row in a matrix F and stands for a reaction force of the i^{th} tooth,

$${f}_{( i )} = ( \begin{matrix}{f}_{( i ) 1} \\ {f}_{( i ) 2} \\ ⋮ \\ {f}_{( i ) 6}\end{matrix} ) \qquad Equation ( 7 )$$

wherein, corresponding to u₍ᵢ₎₁˜u₍ᵢ₎₆, f₍ᵢ₎₁˜f₍ᵢ₎₆ respectively stand for forces and torques of the i^{th} tooth in directions of the three translational degrees of freedom and three rotational degrees of freedom.
wherein i and j stands for numbers of teeth. In this embodiment, simulation is performed for a single jaw (e.g., the upper jaw or lower jaw), so the maximum value of i and j is 14.

In a case where a tooth misses, the corresponding item in the above matrix may be assigned a value of 0.

For ease of illustration, the designing and making of the first shell-shaped tooth repositioner will be described below based on an example in which a single canine is to be repositioned in distal direction by 0.2 mm. In this example, compared with the first tooth arrangement, the canine in the second tooth arrangement is repositioned in distal direction by 0.2 mm.

In the above example, u₍₃₎₁=−0.2; other items in the matrix U are all 0, the matrix U is substituted into Equation (1) to calculate a 84*1 determinant, and its items respectively correspond to the loads of the 14 teeth in directions of the six degrees of freedom. The calculated ideal force system is a 2N load on the canine in distal direction.

In 105, a force system that can be generated by the first design of the first shell-shaped tooth repositioner is calculated.

In one embodiment, a tooth receiving cavity of the first design of the first shell-shaped tooth repositioner matches the patient's teeth under the second tooth arrangement.

Since a force and a reaction force are mutual, in the example in which the canine is to be repositioned in distal direction by 0.2 mm, there are certainly teeth other than the canine that will receive forces when the repositioner of the first design is worn on the teeth. For example, a front molar will receive a force in mesial direction. In addition, an un-designed force besides the force for repositioning the canine in distal direction will be generated when the repositioner is worn, for example, the canine might the subject to a distal tilt torque.

In one embodiment, the simplified mathematical model may be used to calculate the force system that will be generated when the repositioner of the first design is worn on the patient's teeth under the first tooth arrangement, as the first reference force system.

When the simplified mathematical model is used to calculate the force system that can be generated by the repositioner, each item of the matrix K is jointly and solely determined by the material of the repositioner and tooth geometry (including an initial tooth arrangement, tooth crown geometry and tooth root geometry), and is marked as matrix Kₐ. In one embodiment, each item in the matrix Kₐ may be obtained by finite element simulation on wearing of the repositioner, each simulation is performed for a maximum design amount of a single tooth in a single direction, each simulation obtains 84 values which constitute a column of the matrix Kₐ, and a total of 84 simulations are performed to constitute the complete matrix Kₐ.

As for the above example in which the canine is to be repositioned in distal direction by 0.2 mm, when the performance and thickness of a film material for making the repositioner are given, the following reference system is calculated:
The canine receives a force f₍₃₎₁′=0.9 N in distal direction (in the ideal force system, the canine receives a force f₍₃₎₁=2N in distal direction);
The canine receives a torque f₍₃₎₄′=10 Nmm in distal direction (in the ideal force system, the canine receives a torque f₍₃₎4=0 Nmm in distal direction);
The front molar receives a torque f₍₄₎₄′=7 Nmm in mesial direction (in the ideal force system, the front molar receives a torque f₍₄₎4=0 Nmm in mesial direction);
It is known based on the first reference force system, the repositioner of the first design cannot achieve the repositioning target (i.e., repositioning the canine in distal direction by 0.2 mm), and on the other hand, it might cause an undesired repositioning amounts of the teeth. Obviously, the first design is not qualified, so it is necessary to provide a new repositioner design.

In one embodiment, an optimized force system may be generated without changing the original repositioning path (i.e., still taking the second tooth arrangement as design target), and then the second design may be generated based on the first design, according to a difference between the reference force system and the optimized force system.

In 107, a first optimized force system is generated based on given conditions by taking the first ideal force system as target.

In one embodiment, when the first optimized force system is generated, the following factors may be considered: maximum repositioning forces that can be achieved by the repositioner, a repositioning requirement (e.g., root-control requirement and vertical direction control requirement etc.), and forces received by anchorage teeth, etc.

As for the example in which the canine is to be repositioned in distal direction by 0.2 mm, calculation may be performed based on structure and material performance of the repositioner to obtain a maximum force in distal direction that can be applied by the repositioner on the canine. If within the elastic range of the repositioner, the maximum force can reach f₍₃₎₁ (i.e., the force received by the canine in distal direction in the perfect force system which equals 2N), target of a corresponding force in the optimized force system may be set as f_{(3)1_target}=f(3)1. If within the elastic range of the repositioner, the maximum force f₍₃₎₁” cannot reach f₍₃₎₁ (certainly, f₍₃₎₁” f₍₃₎₁′), the target of a corresponding force in the optimized force system may be set as f₍₃₎₁ target=f₍₃₎₁”.

In one embodiment, when the simplified mathematical model is used to calculate the maximum repositioning force in a direction that can be achieved by the repositioner on a tooth, a maximum deformation amount that can be achieved by the repositioner in this direction (i.e., the maximum deformation amount that can be achieved by the repositioner before yield) may be taken as the repositioning amount in this direction, other items other than the items on the main diagonal (i.e., parameters related to the loads of corresponding teeth in corresponding directions) in the matrix Kₐ may be set to zero, and the maximum repositioning force that can be achieved by the repositioner in the direction may be calculated according to Equation (1) based on the repositioning amount and the updated matrix Kₐ.

In one example, calculation is performed based on the given structure and material performance of the repositioner to obtain f₍₃₎₁”=1 N, and correspondingly f_{(3)1_target}=1 N.

In another aspect, in the optimized force system, a limit of torque load on a tooth may be set based on root-control requirement of the tooth. For example, a ratio of the force load to the torque load on the same tooth in the optimized force system may be consistent with that of the ideal force system.

$${f}_{( 3 ) 4 \_ target} / {f}_{( 3 ) 1 \_ target} = {f}_{( 3 ) 4} / {f}_{( 3 ) 1} \qquad Equation ( 8 )$$

As for the example in which the canine is to be repositioned in distal direction by 0.2 mm, since f₍₃₎₄=0 Nmm in the ideal force system, f_{(3)4_target}=0 Nmm in the optimized force system.

Inspired by the present application, it is understood that in addition to the above example of limiting the ratio of the force to the torque, the limitation of the torque based on the root-control need may also be limiting the torque only to make it smaller than a predetermined value, or limiting the ratio of the force to the torque to make the ratio fall within a predetermined range, as long as the limitation of the torque satisfies the root-control need.

It is discovered from extensive clinical experiments that a load smaller than a certain critical value will not cause alveolar bone remolding, that is to say, under such circumstance the tooth will not move actually. Therefore, a tooth may be taken as an anchorage tooth if the load on the tooth is smaller than the critical value. It is understood that the critical values of different teeth in directions of different degrees of freedom might be different. For example, 0.4 N may be taken as the critical value of repositioning in distal direction of canine, and 5 Nmm may be taken as the critical value of mesial tilt of premolar.

The following first optimized force system may be generated based on the above:
The load in distal direction on the canine:

f_{(3)1_target}=1N;
The torque in distal direction on the canine:

f_{(3)4_target}=0Nmm;
The mesial tilt torque on the premolar:

f_{(4)4target}=5Nmm.

In an embodiment, a computer may take the first ideal force system as target, and automatically generate the first optimized force system based on the first reference force system and the given conditions.

In 109, the second design is generated based on the first design and the difference between the first optimized force system and the first reference force system.

The first optimized force system is to be achieved by the repositioner of the second design.

Therefore, in one embodiment, the first design may be modified according to the difference between the first optimized force system and the first reference force system, to obtain the second design.

As for the example in which the canine is to be repositioned in distal direction by 0.2 mm, the difference between the first reference force system and the first optimized force system calculated above is as follows:
The difference between the loads in distal direction on the canine is:

$${f}_{( 3 ) 1 \_ d} = {f}_{( 3 ) 1 \_ target} - {f}_{( 3 ) 1} ’ = 1 - 0.9 = 0.1 N ;$$

The difference between the mesial torques on the canine is:

$${f}_{( 3 ) 4 \_ d} = {f}_{( 3 ) 4 \_ target} - {f}_{( 3 ) 4} ’ = 0 - ( - 10 ) = 10 Nmm ;$$

The difference between the mesial torques on the premolar is:

$${f}_{( 4 ) 4 \_ d} = {f}_{( 4 ) 4 \_ target} - {f}_{( 4 ) 4} ’ = 5 - 7 = - 2 Nmm .$$

The difference between the first reference force system and the first optimized force system may be referred to as a first compensatory force system. Hereunder, the first reference force system may be marked as S′, the first optimized force system may be marked as S_{target}, and the first compensatory force system may be marked as S_d.

Note that when a force system is changed by changing the design of the repositioner, an undesirable change of the force system might be caused. Therefore, the process of generating the second design (i.e., a process of generating a compensatory design amount based on the first design) is a process of iteratively seeking for an optimal solution.

A process of generating the compensatory design amount will be described in detail by taking the above case, in which the canine is to be repositioned in distal direction by 0.2 mm, for example.

In one embodiment, the first design may be modified by adjusting the design amount to obtain the second design. In one embodiment, adjusting the design amount may be adjusting poses of corresponding teeth of the second tooth arrangement which is the basis of the design of the repositioner so that the displacement amounts of the corresponding teeth between the adjusted second tooth arrangement and the first tooth arrangement are adjusted.

First, initial values of the compensatory design amount may be given according to the first compensatory force system, as a starting point of the iterative optimization.

In this example, the initial values of the compensatory design amount may be as follows:

Reposition of the canine in distal direction: 0.02 mm (the force received by the canine in distal direction corresponding to the design amount of repositioning the canine in distal direction by 0.2 mm is 0.9 N; a design amount of approximately 0.02 mm needs to be increased on the basis of the first design in order to achieve the force of 0.1 N in distal direction on the canine in the compensatory force system);

Mesial tilt of the canine: 1.5 degrees (a design amount of 1.5 degrees mesial tilt of the canine needs to be added on the basis of the first design in order to achieve a mesial torque of 10 Nmm in the compensatory force system);

Distal tilt of the premolar: 0.3 degrees (a design amount of 0.3 degrees of distal tilt of the premolar needs to be added on the basis of the first design in order to achieve a distal torque of−2 Nmm in the compensatory force system).

It should be noted that introduction of these compensatory design amounts might cause forces in other directions, for example, the mesial tilt compensatory design amount of the canine will cause a lingual tilt torque on the incisor, and its impact needs to be reduced as much as possible during the subsequent iterations.

In one embodiment, for the iterations, each tooth may be given a boundary constraint in each degree of freedom, for example, a tilt compensation amount of a single tooth may be limited to no more than 2 degrees.

In one embodiment, for the iterations, a global constraint may also be given, for example, a sum of absolute values of tilt compensation amounts of all teeth may be limited to no more than 5 degrees.

Then, an optimization function may be used to perform the iterations to seek for an optimal solution of the compensatory design amount. In one embodiment, the optimization function may be defined as minimizing a sum of squares of compensatory loads of all teeth (for forces and torques, different weights may be given in the calculation).

Then, a minimum value may be obtained by solving a non-linear problem with constraints based on the optimization function. For example, a sequential quadratic programming method may be used. Reference may be made to “A Software Package for Sequential Quadratic Programming” published by Kraft D (1988) in Tech. Rep. DFVLR-FB 88-28, DLR German Aerospace Center—Institute for Flight Mechanics, Koln, Germany, for specific implementation.

A final compensatory design amount may be calculated using the above method.

In the above example in which the canine is to be repositioned in distal direction by 0.2 mm, the following final compensatory design amount may be calculated using the above method: the canine is to be tilted in mesial direction by 1.2 degrees and extruded by 0.05 mm, the incisor is to be tilted in buccal direction by 0.4 degrees and intruded by 0.05 mm, and the first molar is to be intruded by 0.03 mm.

In the end, the final compensatory design amount is combined with the design amount of the first design, to obtain the design amount of the second design.

In the above example in which the canine is to be repositioned in distal direction by 0.2 mm, the design amount of the second design is as follows: the canine is to be repositioned in distal direction by 0.2 mm, titled in mesial direction by 1.2 degrees and extruded by 0.05 mm, the incisor is to be tilted in buccal direction by 0.4 degrees and intruded by 0.05 mm, and the first molar is to be intruded by 0.03 mm.

The shell-shaped tooth repositioner forms a cavity for receiving a plurality of teeth, a part corresponding to a tooth may be referred to as a tooth cavity of the tooth, and the positional relationship between these tooth cavities determines, to a certain degree, the forces applied by the shell-shaped tooth reposition on the teeth. In one embodiment, the adjustment of the design amount refers to changing the positional relationship between these tooth cavities to change the forces applied by the shell-shaped tooth repositioner.

Inspired by the present application, it is understood that there are many means for modifying the design of a repositioner in addition to the above adjustment of the design amount, including: modifying local geometry (changing the force applied on a tooth by changing the geometry of the cavity for receiving the tooth, a repositioning force or an anchorage force applied on the tooth may be adjusted by this means), adding a force applying structure at a point and adding a local reinforcing structure etc.

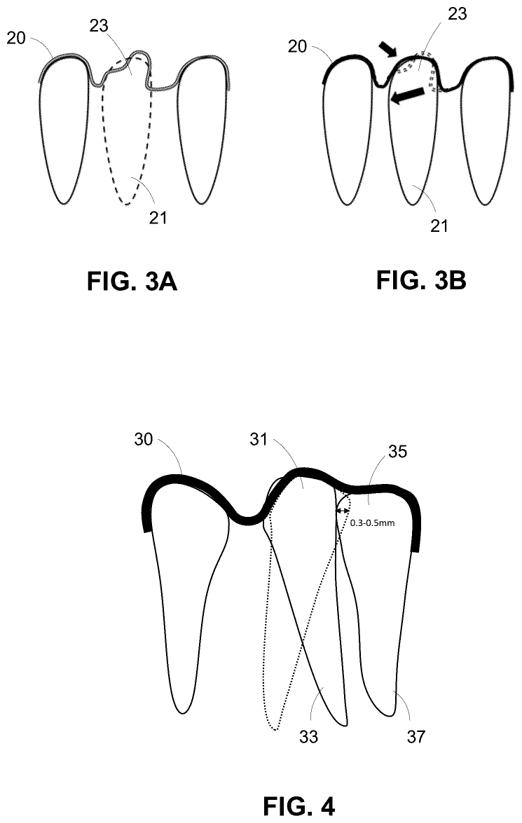

Referring to FIG. 3A, it schematically illustrates an optimized design 20 of a shell-shaped tooth repositioner according to an embodiment of the present application, wherein the geometry of a tooth cavity 23 for receiving a tooth 21 (denoted in dotted-line) does not conform to the tooth 21. As compared with the geometry of the tooth 21, the geometry of the tooth cavity 23 slightly narrows in the right upper side and is recessed inwardly in the left upper side.

Referring to FIG. 3B, it schematically illustrates the deformation of the shell-shaped tooth repositioner shown in FIG. 3A when it is worn on the teeth, the shell-shaped tooth repositioner generating additional forces in directions indicated by two arrows in the figure on the tooth 21.

In one embodiment, local geometry modification may be modifying local geometry of the design of a repositioner, to change the force system applied by the repositioner to the teeth. Unlike adjustment of design amount, a part of a repositioner whose local geometry is modified and a corresponding tooth crown have different geometries and do not match each other anymore.

In one embodiment, adding a force-applying structure which applies a force at a point is forming a convex point in the tooth-receiving cavity of a repositioner, when the repositioner is worn on the teeth, the convex point abuts against the surface of a tooth to form a new force-applying point.

In one embodiment, increasing local thickness may be increasing the thickness of a local part of a repositioner by an additive manufacturing process, to change the mechanical performance of the local part of the repositioner.

In one embodiment, local material modification may be modifying the material of a local part of a repositioner by a material modifying process, to change the mechanical performance of the local part of the repositioner.

In one embodiment, adding a reinforcing rib may be providing a reinforcing rib at a predetermined position of the repositioner, to change the mechanical performance of the corresponding part.

In one embodiment, as for corresponding means of modifying a repositioner, operators and their corresponding effects (i.e., resultant differences of force systems) may be preset in a computer program, so that the computer can automatically select a corresponding operator according to a difference between the optimized force system and the reference force system, to modify the first design. For example, for an adjustment of design amount of repositioning a canine in distal direction, the operator may be set at a step length of 0.02 mm, and an effect corresponding to the operator is a force of 0.1 N.

In one embodiment, an operator selecting strategy may be set in the computer program so that the computer can automatically selects operators in the iterations according to the strategy.

In 111, a fourth tooth arrangement that can be achieved by the second design is calculated.

Although the second design aims to achieve the second tooth arrangement, the tooth arrangement that can be actually achieved by the second design might not match the second tooth arrangement. The fourth tooth arrangement that can actually be achieved by the second design needs to be calculated in order to generate an optimal design of the second shell-shaped tooth repositioner. The second tooth arrangement is a tooth arrangement in the initial repositioning plan.

In one embodiment, the fourth tooth arrangement that can be achieved by the second design may be calculated by the following method.

A load received by the i^{th} tooth in a direction j at a time point t is marked as x, a duration is marked as t0, and a repositioning amount D that can be achieved may be defined by the following Equation (9):

$$D = {\int }_{t}^{{t}_{0}} {f}_{i , j} ( x ( t ) ) dt \qquad Equation ( 9 )$$

In an actual situation, the loads applied by a repositioner on the teeth varies with the movements of the teeth. In one embodiment, to simplify the calculation, when the repositioning amount is calculated according to Equation (9), the load x may be set invariable, and the impact introduced by this may be balanced by other parameters. In one embodiment, fij may be defined by the following Equation (10):

$${f}_{i , j} = \{ \begin{matrix}0 , & x \leq {T}_{i , j} \\ a ( x - {T}_{i , j} ) , & {T}_{i , j} < x \leq {Y}_{i , j} \\ {aY}_{i , j} , & {Y}_{i , j} < x \leq {B}_{i , j} \\ 0 , & x > {B}_{i , j}\end{matrix} \qquad Equation ( 10 )$$

wherein a, Tᵢⱼ, Yᵢⱼ and Bᵢⱼ all are parameters and may be preset based on experience, big data and experiments etc. It is to note that for different teeth and different repositioning directions of a same patient, each parameter might have a different value, and N sets of parameters (N is a natural number greater than or equal to 1) may be obtained after permutation, and therefore N results D₁, D₂, . . . D_{N} may be obtained accordingly. Then, a probability or weight of each of the N results may be calculated, and in the end the repositioning amount D may be calculated based on the N results and probabilities thereof.

In one embodiment, positional relationships between adjacent teeth are taken into consideration. The probability of each result may be calculated by the following method.

An initial distance between origins of coordinate systems of two adjacent teeth is marked as dini, the distance when a single-step design amount is achieved is marked as d_{des}, a minimum distance is marked as dₘᵢₙ (if the distance is too short, the two adjacent teeth will collide with each other), and the distances between the origins corresponding to the N results are marked as d₁, d₂, . . . d_{N}, respectively. In one embodiment, the probability of each result may be calculated according to the following Equation (11):

$${P}_{k} = \{ \begin{matrix}{e}^{\frac{\vert {d}_{k} - {d}_{des} \vert}{\vert {d}_{ini} - {d}_{des} \vert}} , & d \geq {d}_{min} \\ 0 , & d < {d}_{min}\end{matrix} \qquad Equation ( 11 )$$

Then, the repositioning amount D that can be achieved may be calculated according to the following Equation (12):

$$D = \frac{{\sum }_{k = 1}^{N} {D}_{k} \times {P}_{k}}{{\sum }_{k = 1}^{N} {P}_{k}} \qquad Equation ( 12 )$$

The calculation of the repositioning amount that can be achieved will be described below based on the second design by taking tilt in distal direction of the canine that can be achieved for example.

A distal-tilt torque of 3 Nmm of the canine is calculated based on the second design. It is calculated according to the geometry of the tooth, a distal tilt amount of 1° corresponds to a movement amount of 0.1 mm. If there are three sets of parameters listed in the following Table 1, corresponding three sets of repositioning amounts of distal tilt of the canine and the probabilities thereof may be calculated.

TABLE 1

| Parameter Setting | Repositioning Amount | Probability |
|---|---|---|
| a = 1, T = 2, Y = 10, B = 30 | D₁ = (3 − 2)*1 = 1° | P = e\hat{ }(−0.1/0.2) = 0.61 |
| a = 2, T = 4, Y = 15, B = 30 | D₂ = 0 | P = e\hat{ }(−0/0.2) = 1 |
| a = 2, T = 1, Y = 10, B = 30 | D₃ = (3 − 1)*2 = 4° | P = e\hat{ }(−0.4/0.2) = 0.13 |

The final amount of distal tilt that can be achieved is:

$$D = ( 1 * 0.61 + 0 * 1 + 4 * 0.13 ) / ( 0.61 + 1 + 0.13 ) = 0.6 {5}^{∘}$$

The repositioning amount of each tooth in each direction that can be achieved by the second design may be calculated by the above method, and thereby the fourth tooth arrangement may be calculated based on these repositioning amounts and the first tooth arrangement.

Inspired by the present application, it is understood that besides the above method, other suitable methods may also be employed to calculate the repositioning amounts that can be achieved. For example, a definite element analysis method may be employed: a finite element model of the shell-shaped tooth repositioner is worn on a finite element model of a jaw (including teeth and periodontal tissue) to obtain the repositioning amounts by simulation.

The first tooth arrangement is replaced by the fourth tooth arrangement, the second tooth arrangement is replaced by the third tooth arrangement, and a third design of the second shell-shaped tooth repositioner is generated based on the third tooth arrangement as reference design. On this basis, the operations of 101 through 109 may be repeated to obtain an optimized fourth design of the second shell-shaped tooth repositioner.

It is understood that a tooth repositioning plan may comprise an accessory design, which comprises types of accessories, mounting positions of the accessories (on which teeth the accessories are to be mounted, and positions on the surfaces of the teeth where the accessories are to be mounted at), timing of adding the accessories (in which repositioning steps the accessories are to be added), etc.

In one embodiment, as for an optimized design of an entire set of shell-shaped tooth repositioners (including a series of successive shell-shaped tooth repositioners) for implementing a tooth repositioning plan (comprising a series of successive repositioning steps), the optimized design of each shell-shaped tooth repositioner differs from the corresponding reference design in geometry only, that is to say, it does not change the design of the mounting positions and timing of adding the accessories in the initial tooth repositioning plan.

Usually, a tooth repositioning plan does not allow a collision between teeth greater than 0.2 mm. In one embodiment, collisions between teeth are allowed to be greater than the threshold in an optimized design of shell-shaped tooth repositioners. For example, this threshold may be increased to 0.3-0.5 mm. This is because a shell-shaped tooth repositioner forms a cavity for receiving teeth, the positional relationship between tooth cavities determines the forces applied by the shell-shaped tooth repositioner to the teeth to a certain degree and overlap of the cavities of two adjacent teeth can provide an additional compensatory force. Under a reasonable design, this does not cause the two adjacent teeth to really collide with each other during the repositioning. In other words, an optimized design allows a larger range of local overlap of the tooth cavities of two adjacent teeth than conventional method of designing shell-shaped tooth repositioners, and this is also applicable for local overlap of the tooth cavities and accessory cavities (accessory cavities refer to cavities of a shell-shaped tooth repositioner for receiving accessories attached on surfaces of teeth).

Referring to FIG. 4, it schematically illustrates an optimized design 30 of a shell-shaped tooth repositioner according to an embodiment of the present application. The optimized design comprises a tooth cavity 31 for receiving a tooth 33, and a tooth cavity 35 for receiving a tooth 37, wherein the teeth 33 and 37 are two adjacent teeth, wherein a dotted-line portion shows the position of the tooth cavity 31 in the optimized design, and the tooth cavities 31 and 35 overlap partially.

Although the above embodiment only illustrates how to generate the designs of the two shell-shaped tooth repositioners of two successive repositioning steps, it is understood that for more successive repositioning steps, corresponding designs of the shell-shaped tooth repositioners may be obtained by repeating corresponding operations based on the corresponding tooth arrangements.

In 113, the second and fourth designs are used to control an apparatus to make the first and second shell-shaped tooth repositioners.

After the second and fourth designs are obtained, they may be respectively used to control the apparatus to make the first and second shell-shaped tooth repositioners.

In one embodiment, if the shell-shaped tooth repositioners are made by a thermoplastic forming process, the second and fourth designs may respectively comprise a 3D digital model representing a positive model. Therefore, the 3D digital models may be used to control an apparatus (e.g., a stereo lithography apparatus) to make the positive models, and then the first and second shell-shaped tooth repositioners may be obtained by forming on the positive models using the thermoplastic forming technique.

In one embodiment, if the shell-shaped tooth repositioners are made using a 3D printing technique, the second and fourth designs may respectively comprise a 3D digital model representing the first and second shell-shaped tooth repositioners. Therefore, the 3D digital models may be used to control a 3D printing apparatus to directly make the first and second shell-shaped tooth repositioners.

Although the simplified mathematical model is used in all the above examples to calculate the force systems, it is understood that besides the simplified mathematic model, finite element analysis may be used to calculate the force systems. For example, a definite element model of a shell-shaped tooth repositioner may be worn on a finite element model of a rigid dentition, and the force system applied by the shell-shaped tooth repositioner on the teeth may be calculated by a finite element analysis method.

The method of generating designs of shell-shaped tooth repositioners in the present application is implemented by a computer. In one embodiment, a user can interact with the computer via a user interface of a computer program to cause the computer to calculate based on a series of successive tooth arrangements and a series of reference designs of a corresponding series of successive shell-shaped tooth repositioners, to generate optimized designs of the series of successive shell-shaped tooth repositioners.

In one embodiment, through a user interface of the computer program, the computer program can present compensatory force systems or compensatory design amounts to the user visually (e.g., an image or character or a combination thereof).

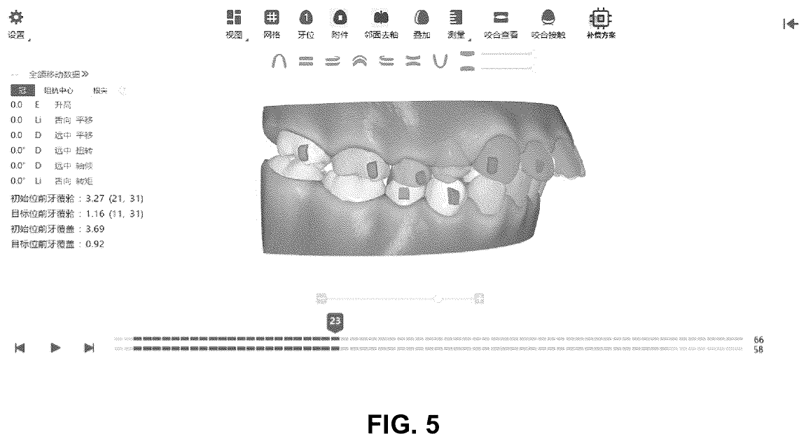

Referring to FIG. 5, it schematically illustrates a user interface of a computer program according to an embodiment of the present application. In this example, the user interface shows teeth on an upper jaw and a lower jaw and represents compensatory design amounts with a shade of color (namely, color purity). The teeth without compensatory design amount are white, the filling color of the teeth darkens as the compensatory design amounts increase, for example, the teeth with a small compensatory design amount are filled with light red, and teeth with a great compensatory design amount are filled with deep red.

Inspired by the present application, it is understood that besides red, purity of any other color may also be used to indicate the magnitude of a compensatory force system or a compensatory design amount. Besides purity of colors, hue or lightness may also be used to indicate the magnitude of a compensatory force system or a compensatory design amount.

Besides colors, pattern density may also be used to indicate the magnitude of a compensatory force system or a compensatory design amount. In a word, any suitable graphic manner may be used to indicate the magnitude of a compensatory force system or a compensatory design amount.

In one embodiment, it is feasible to present per user's selection, a total compensatory force system or compensatory design amount, or a compensatory force system or compensatory design amount in a selected direction, for example, an axis inclination (including mesial tilt and distal tilt), a torque (including lingual tilt of a front tooth crown, buccal tilt of a front tooth crown, lingual tilt of a rear tooth crown and buccal tilt of a rear tooth crown), a torsion, a vertical compensation (comprising extrusion and intrusion) and a total compensation (comprising compensations in all directions).

In one embodiment, per user's selection, the compensatory force system or compensatory design amount of a selected repositioning step may be presented, and the compensatory force system or compensatory design amount of successive repositioning steps may also be presented one by one.

In one embodiment, the teeth on the upper jaw and on the lower jaw presented in the user interface are under a tooth arrangement that can be achieved by the optimize design of the corresponding repositioning step.

In one embodiment, the user interface can simultaneously present an upper-jaw dentition and a lower-jaw dentition, or only one of the upper-jaw dentition and the lower-jaw dentition per user's selection.

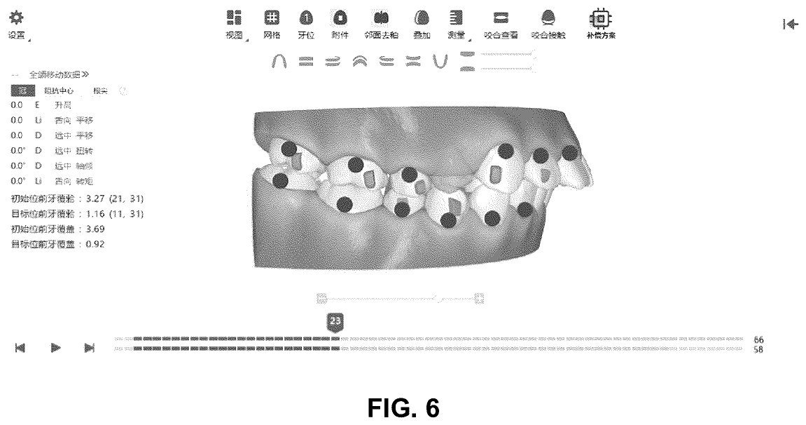

Referring to FIG. 6, it schematically illustrates a user interface of a computer program according to another embodiment of the present application. In this example, the user interface presents the teeth of a upper jaw and a lower jaw, and graphical marks, e.g., circular icons, are provided on the teeth having a compensatory force system/compensatory amount. The computer program may present the compensatory force system/compensatory amount of a corresponding tooth, whose icon is selected by the user, in the form of characters (e.g., the user selects the icon by clicking the icon with a mouse).

Inspired by the present application, it is understood that besides the above embodiments, a compensatory force system/compensatory amount may also be presented in any other suitable manners. For example, a model of teeth in an initial design and a model of teeth in a final design may be overlapped, and positions where the two models are different may be filled with a color or texture to indicate the teeth having a compensatory force system/compensatory amount.

As known from the above, besides adjustment of design amount, an optimized force system may also be achieved by an artificially-designed structure, for example, local geometry modification, a structure for applying a force at a point, increasing thickness of a local area and reinforcement ribs etc. The artificially-designed structure is an artificially-designed structure different from natural geometry of teeth. In case these modifying means are used, if only a compensatory design amount is presented, the changes of the repositioning amounts of the teeth cannot be entirely reflected. Therefore, in order to entirely present the changes of the repositioning amounts of the teeth caused by the modified design, in one embodiment, the compensatory force system may be converted into an equivalent compensatory design amount (i.e., assuming that the compensatory force system is implemented only by adjusting the design amount, the corresponding compensatory design amount is calculated based on the compensatory force system, and regarded as the equivalent compensatory design amount), and the compensatory design amount or equivalent compensatory design amount may be presented per user's selection.

In another aspect, the present application provides a system of designing and manufacturing shell-shaped tooth repositioners. Dentists, shell-shaped tooth repositioner designers and production managers exchange data through this system and use this system to carry out designing and fabricating shell-shaped tooth repositioners based on relevant data.

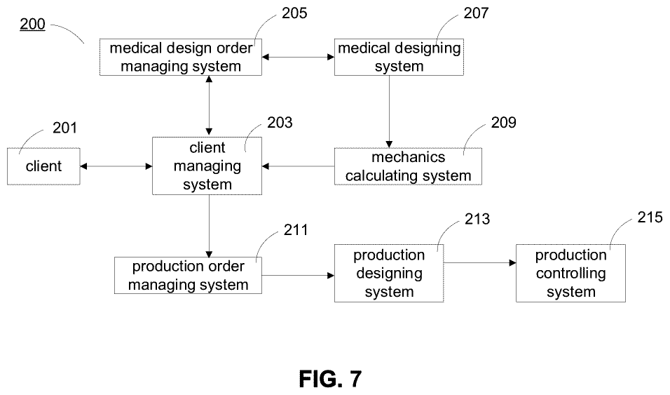

Referring to FIG. 7, it schematically illustrates a block diagram of a system 200 for designing and manufacturing shell-shaped tooth repositioners according to an embodiment of the present application.

The system 200 for designing and manufacturing the shell-shaped tooth repositioner comprises a client 201, a client managing system 203, a medical design order managing system 205, a medical design system 207, a mechanics calculating system 209, a production order managing system 211, a production designing system 213 and a production controlling system 215.

The client 201 is a dentist's computer terminal. In one embodiment, it may be a computer installed with a client computer program. The dentist can propose a need to design a tooth repositioning plan through the client 201.

Although FIG. 7 only shows one client 201, it is understood that a plurality of clients 201 may be provided for use by different dentists.

The client managing system 203 stores and manages dentists' access rights and patients' data and serves as an interface between subsystems.

After a patient who needs an orthodontic treatment is diagnosed, a dentist may send a 3D digital model representing the patient's current tooth arrangement and diagnosis (e.g., requirements for the orthodontic treatment) etc. to the client managing system 203 through the client 201.

After receipt of the dentist's order, the client managing system 203 sends the order to the medical design order managing system 205 which in turn assigns the design order to a corresponding medical designer. When the medical designer receives the medical design order, he/she may use the medical design system 207 to generate an orthodontic treatment plan (including all tooth arrangements from the current tooth arrangement to a target tooth arrangement) and a corresponding reference designs of shell-shaped tooth repositioners, based on the 3D digital model representing the patient's current tooth arrangement and the diagnosis. In one embodiment, the reference designs of the shell-shaped tooth repositioners may be a series of successive shell-shaped tooth repositioners that match the series of successive tooth arrangements respectively.

In one embodiment, the medical design system 207 may be a computer installed with a computer program for generating an orthodontic treatment plan and reference designs of the shell-shaped tooth repositioners. Although FIG. 7 only shows one medical design system 207, it is understood that a plurality of medical design systems may be provided for use by a plurality of medical designers respectively.

After receipt of the orthodontic treatment plan, the client managing system 203 will send a notification to the client 201, and the dentist can review the orthodontic treatment plan on the client 201. If the dentist believes that the orthodontic treatment plan is unreasonable, he/she may propose an amendment through the client 201, the client managing system 203 sends the amendment to the medical design order managing system 205, and the medical designer re-designs the orthodontic treatment plan based on the amendment until the dentist's requirements are satisfied.

After the dentist confirms the orthodontic treatment plan, the client managing system 203 will send a notification to the medical design order managing system 205, the orthodontic treatment plan and the corresponding reference designs of the shell-shaped tooth repositioners are sent to the mechanics calculating system 209, and the mechanics calculating system 209 generates a final design of shell-shaped tooth repositioners according to the method of the present application and sends the final design to the client managing system 203.

After the dentist confirms a production order through the client 201, the client managing system 203 will send the final designs of the shell-shaped tooth repositioners to the production order managing system 211, then the production order managing system 211 sends the final designs to the production designing system 213 to generate a 3D digital model of a corresponding series of successive positive models needed in the production, then the 3D digital model is sent to the corresponding production controlling system 215, and the production controlling system 215 controls a production apparatus to make a corresponding series of shell-shaped tooth repositioners.

It is understood that as long as a computing device has sufficient processing capability, the above subsystems may be run on the same computing device. For example, the production order managing system 211 and the production designing system 213 may be run on the same computing device; in another example, the medical order managing system 205, the client managing system 203 and the production order managing system 211 may be run on the same computing device.

In one embodiment, some subsystems may be located at different locations and may be connected through a network.

In a conventional solution, in the process of designing shell-shaped tooth repositioners based on an orthodontic treatment plan confirmed by a dentist, if a medical designer discovers the reference designs of the shell-shaped tooth repositioners cannot achieve the corresponding orthodontic treatment plan, the initial orthodontic treatment plan will be modified, and the dentist needs to consider and confirm after each modification, which will take the dentist a lot of time. In the solution of the present application, if it is discovered that the reference designs of the shell-shaped tooth repositioners cannot achieve the confirmed orthodontic treatment plan, the mechanics calculating system 209 will modify the reference designs of the shell-shaped tooth repositioners based on factors such as mechanics properties of materials without changing the orthodontic treatment plan confirmed by the dentist, to obtain the optimized designs of the shell-shaped tooth repositioners capable of achieving the orthodontic treatment plan. In one aspect, this saves the dentist's time; in another aspect, this optimized design makes full use of the properties of the materials and structures and puts the shell-shaped tooth repositioners to full play; in a further aspect, the dentist only needs to participate in the design of the orthodontic treatment plan and needn't participate in the design of the shell-shaped tooth repositioners. Usually, dentists have advantages in medical profession and do not necessarily fully understand the properties of materials and various structures of shell-shaped tooth repositioners. Therefore, this mode enables all parties to give their respective professional advantages to full play. It is to note that terms such as “first”, “second” and “third” in the present application do not indicate special referents, and the content referred to by them needs to be determined according to the context.

It is to note that “arrangement” and “tooth arrangement” mean the same in the present application.

It is understood that as for an entire tooth repositioning plan, there is an initial tooth arrangement (the patient's tooth arrangement before the orthodontic treatment) and a target tooth arrangement (i.e., a tooth arrangement to be achieved by the orthodontic treatment plan); as for each repositioning step, there is also an initial tooth arrangement (the initial tooth arrangement of the repositioning step) and a target tooth arrangement (i.e., a tooth arrangement to be achieved by the repositioning step).

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. A computer-implemented method of generating designs of shell-shaped tooth repositioners, the method comprising:
obtaining an orthodontic treatment plan comprising a series of successive repositioning steps whose repositioning targets are successive tooth arrangements including a first intermediate tooth arrangement, . . . a final intermediate tooth arrangement and a target tooth arrangement;
obtaining reference designs of a series of successive shell-shaped tooth repositioners corresponding to the series of successive repositioning steps;
calculating whether the reference designs of the series of successive shell-shaped tooth repositioners are able to achieve corresponding repositioning targets; and
if a reference design of a shell-shaped tooth repositioner of a repositioning step is not able to achieve the repositioning target of the repositioning step, modifying geometry of a corresponding part of the reference design of the shell-shaped tooth repositioner of the repositioning step, to improve force application of the shell-shaped tooth repositioner to obtain an optimized design of the shell-shaped tooth repositioner of this repositioning step.

2. The computer-implemented method according to claim 1, wherein the reference designs of the series of successive shell-shaped tooth repositioners are directly generated based on the geometries of the repositioning targets of the series of successive repositioning steps respectively.

3. The computer-implemented method according to claim 2, wherein the geometries of the reference designs of the series of successive shell-shaped tooth repositioners match the repositioning targets of the series of successive repositioning steps respectively.

4. The computer-implemented method according to claim 1, wherein the optimized design of the shell-shaped tooth repositioner differs from the corresponding reference design in geometry only.

5. The computer-implemented method according to claim 1, wherein each of the shell-shaped tooth repositioners forms a cavity for receiving a plurality of teeth, a part thereof for receiving a single tooth is referred to as a tooth cavity of the tooth, and the optimized design of the shell-shaped tooth repositioner allows partial overlap of tooth cavities of two adjacent teeth.

6. The computer-implemented method according to claim 5, wherein the partial overlap of the tooth cavities allowed by the optimized design of the shell-shaped tooth repositioner is in a range of 0.3˜0.5 mm.

7. The computer-implemented method according to claim 1, wherein each of the shell-shaped tooth repositioners forms a cavity for receiving a plurality of teeth and an accessory attached to the surface of a tooth, a part thereof for receiving a single tooth is referred to as a tooth cavity of the tooth, a part thereof receiving an accessory is referred to as an accessory cavity of the accessory, and the optimized design of the shell-shaped tooth repositioner allows partial overlap of a tooth cavity and an accessory cavity.

8. The computer-implemented method according to claim 1 further comprising:
for each of the series of successive repositioning steps, calculating based on its initial tooth arrangement and target tooth arrangement to obtain an ideal force system for repositioning the teeth from the initial tooth arrangement to the target tooth arrangement;
calculating based on the initial tooth arrangement and the reference design of the shell-shaped tooth repositioner to obtain a reference force system applied on the teeth when the shell-shaped tooth repositioner of the reference design is worn on the teeth under the initial tooth arrangement; and
modifying the reference design based on the ideal force system and the reference force system to obtain the optimized design.

9. The computer-implemented method according to claim 8, further comprising:
calculating based on a given condition by taking the ideal force system as a target to obtain an optimized force system; and
modifying the reference design according to a difference between the reference force system and the optimized force system to obtain the optimized design.

10. The computer-implemented method according to claim 9 further comprising: according to a user instruction, presenting one of the following of a selected repositioning step on a user interface: a compensatory force system, a compensatory design amount, an equivalent compensatory design amount and any combinations thereof, wherein a compensatory force system is a difference between a reference force system and a corresponding optimized force system, a compensatory design amount is a difference between design amounts of a reference design and a corresponding optimized design, and an equivalent compensatory design amount is a compensatory design amount obtained by calculating based on a corresponding compensatory force system.

11. The computer-implemented method according to claim 10 further comprising: presenting the patient's jaw on the user interface, wherein each tooth having compensatory force systems in the jaw are tagged with marks to indicate one of the following: a compensatory force system, a compensatory design amount and an equivalent compensatory design amount.

12. The computer-implemented method according to claim 9, wherein the given condition comprises: a maximum load of the shell-shaped tooth repositioner calculated based on a given material and thickness of the shell-shaped tooth repositioner.

13. The computer-implemented method according to claim 8, wherein a force system is a sum of a static force and a static torque.

14. The computer-implemented method according to claim 1 further comprising:
obtaining a 3D digital model representing the patient's initial tooth arrangement and a diagnosis provided by a dentist;
generating the orthodontic treatment plan based on the 3D digital model representing the patient's initial tooth arrangement and the diagnosis; and
generating the reference designs of the series of successive shell-shaped tooth repositioners after obtaining the dentist's confirmation of the orthodontic treatment plan.

15. The computer-implemented method according to claim 1, wherein modifying the geometry of the corresponding part of the reference design of the shell-shaped tooth repositioner of the repositioning step comprises one of the following: changing positional relationship between tooth cavities, changing the geometries of tooth cavities, adding a pressure point, adding a local reinforcement structure, and any combination thereof, wherein the shell-shaped tooth repositioner forms a cavity for receiving a plurality of teeth, and a part thereof for receiving a single tooth is referred to as a tooth cavity of the tooth.

16. A shell-shaped tooth repositioner system, comprising:
a series of successive shell-shaped tooth repositioners for incrementally repositioning teeth from an initial tooth arrangement to a first intermediate tooth arrangement, . . . a final intermediate tooth arrangement until a target tooth arrangement, wherein the series of successive shell-shaped tooth repositioners are obtained by modifying corresponding reference designs of the series of successive shell-shaped tooth repositioners, the modifications are based on differences between actual repositioning performances and desired repositioning performances of the reference designs of the series of successive shell-shaped tooth repositioners, and the geometry of at least one of the series of successive shell-shaped tooth repositioners is different from that of the corresponding reference design, wherein the reference designs of the series of successive shell-shaped tooth repositioners are directly generated based on the first intermediate tooth arrangement, . . . the final intermediate tooth arrangement and the target tooth arrangement, respectively.

17. The shell-shaped tooth repositioner system according to claim 16, wherein the geometries of the reference designs of the series of successive shell-shaped tooth repositioners matches the first intermediate tooth arrangement, . . . the final intermediate tooth arrangement and the target tooth arrangement, respectively.

18. The shell-shaped tooth repositioner system according to claim 16, wherein the actual repositioning performances and the desired repositioning performances are expressed by static force systems.

19. A computer-implemented method of generating designs of shell-shaped tooth repositioners, the method comprising:
obtaining an initial tooth arrangement and a target tooth arrangement of a first repositioning step;
obtaining a reference design of the shell-shaped tooth repositioner of the first repositioning step;
calculating a force system applied on a patient's teeth when the shell-shaped tooth repositioner of the reference design is worn on the patient's teeth under the initial tooth arrangement, which force system is referred to as a reference force system;
calculating based on the initial tooth arrangement and the target tooth arrangement to obtain an ideal force system which is a force system required to be applied on the teeth when the shell-shaped tooth repositioner is worn on the patient's teeth under the initial tooth arrangement to reposition the patient's teeth from the initial tooth arrangement to the target tooth arrangement; and
modifying the reference design based on the reference force system and the ideal force system to obtain an optimized design.

20. The computer-implemented method according to claim 19, wherein the reference design is directly generated based on the target tooth arrangement.

21. The computer-implemented method according to claim 20, wherein a geometry of a cavity of the reference design for receiving teeth matches the target tooth arrangement.

22. The computer-implemented method according to claim 19 further comprising:
obtaining an initial tooth arrangement and an optimized design of a shell-shaped tooth repositioner of a second repositioning step, wherein the second repositioning step is the previous repositioning step of the first repositioning step; and
calculating based on the initial tooth arrangement and the optimized design of the shell-shaped tooth repositioner of the second repositioning step to obtain the initial tooth arrangement of the first repositioning step.

23. The computer-implemented method according to claim 19 further comprising:
calculating based on a given condition by taking the ideal force system as target, an optimized force system; and
modifying the reference design according to the difference between the reference force system and the optimized force system to obtain the optimized design.

24. The computer-implemented method according to claim 23, wherein the force system is a sum of a static force and a static torque.

25. The computer-implemented method according to claim 23, wherein the given condition comprises: maximum force that can be achieved by the shell-shaped tooth repositioner, based on a given material and thickness.

26. The computer-implemented method according to claim 25, wherein the given condition further comprises one of the following: maximum load of an anchorage tooth, root-control requirement, vertical direction control requirement, and any combination thereof.

27. The computer-implemented method according to claim 19, wherein the modification comprises one of the following: changing a relative positional relationship between tooth cavities, adding an artificially-designed structure and a combination thereof, wherein the shell-shaped tooth repositioner forms a cavity for receiving a plurality of teeth, and a part thereof for receiving a single tooth is referred to as a tooth cavity of the tooth.

28. The computer-implemented method according to claim 27, wherein the artificially-designed structure comprises one of the following: local geometry modification, force-applying structure at a point, local reinforcement structure and any combination thereof.
